(19) United States
(12) Patent Application Publication
(10) Pub. No.: US 2007/0131353 A1
(43) Pub. Date: Jun. 14, 2007

(54) Apparatus and clocked method for pressure-sintered bonding

(75) Inventor: Christian Gobl, Nurnberg (DE)

Correspondence Address: COHEN, PONTANI, LIEBERMAN & PAVANE, 551 FIFTH AVENUE, SUITE 1210, NEW YORK, NY, 10176, US

(73) Assignee: SEMIKRON Elektronik GmbH & Co. KG

(21) Appl. No.: 11/636,845

(22) Filed: Dec. 11, 2006

(30) Foreign Application Priority Data
Dec. 9, 2005 (DE) 10 2005 058 794.1

(51) Int. Cl. B32B 37/00; B30B 9/06

(52) U.S. Cl. 156/297; 156/580; 156/498; 100/113; 228/180.21; 29/729; 29/742

(57) ABSTRACT

An apparatus and a clocked method for pressure-sintered bonding of a plurality of chiplike components to conductor tracks on a substrate. The apparatus has a pressing device, a conveyor belt, and a further device for covering the substrate with a protective film. The pressing device is suitable for clocked operation and has a pressing die with a silicone pressure cushion and a heatable pressing table. The conveyor belt is pressure-stable and extends directly above the pressing table. The protective film is disposed between the substrate, with the components disposed thereon, and the pressing die. During the clocked method, the top side of the substrate is covered with the protective film, and then the pressure-sintering operation is started by pressing the pressure cushion onto the top side of the substrate.

### BACKGROUND OF THE INVENTION

1. Field of the Invention

The invention is directed to a method and apparatus for bonding components to a substrate, and more particularly, to a method and apparatus for simultaneous pressure-sintered bonding of a plurality of chiplike components on a substrate. As used herein “clocked pressure-sintering method” means that, in succession, a plurality of substrates are connected with their respective components via a cyclical method in a defined sequence by means of a suitable apparatus.

2. Description of the Related Art

The fundamental prior art for the invention is German Patent DE 34 14 065 C2 and European Patent Disclosure EP 0 242 626 B1 (from the same patent family as U.S. Pat. No. 4,810,622). DE 34 14 065 C2 discloses a method which includes the following processing steps:

applying a mixture of a pastelike layer, comprising a metal powder and a solvent, hereinafter called sintered metal, to the contact face to be bonded, the face being either of the component or of the substrate;

applying the component to the substrate, with the pastelike layer disposed between the component and the substrate;

expelling the solvent from the composite comprising the component, the pastelike layer, and the substrate; and

subjecting the composite to pressure, preferably with additional heating to sintering temperature, whereupon a pressure-sintered bond is formed between the component and the substrate.

The method disclosed here is for bonding precisely one component and one associated substrate. EP 0 242 626 B1 discloses a further optimized method for this. This method avoids certain disadvantages of the first prior art cited. However, that method, like the first, has the disadvantage of involving a purely serial method, which is an obstacle to modern, rational production of such bonds.

German Patent Disclosure DE 10 2004 019 567 (from which co-pending U.S. patent application Ser. No. 11/112,803, published as United States Published Application No. US 2005/0247760, claims partial priority), which is also prior art, includes principles for making the pressure-sintering method, which until now has been limited to individual components and individual bonds, more easily accessible to automated production. In this reference, special emphasis is placed on coating the components or substrates with the sintered metal.

The prior art, however, fails to teach or disclose any method for easily sintering a plurality of substrates, each substrate being intended for use with a plurality of chiplike components.

### SUMMARY OF THE INVENTION

One object of the invention is to provide an apparatus and an associated method for permitting the clocked pressure-sintering of a plurality of substrates, each of which has a plurality of chiplike components.

The inventive method and apparatus are intended for use with a substrate, preferably comprising a base body and a metal layer disposed thereon. This metal layer has a thin layer of a precious metal on its top side, as is especially preferred as a basis for pressure-sintered bonds. At least one chiplike component is to be disposed on the metal layer of the substrate. In the prior art, the sintered metal is disposed, with a known layer thickness and design, between the components and the metal layer.

The inventive apparatus, which is suitable for a clocked production method of pressure-sintered bonds, has at least one pressing device, a conveyor belt, and a device for covering the substrate with a protective film.

The pressing device is suitable for clocked operation. To that end, it has a pressing die, a heatable and stable pressing table and a conveyor belt. The conveyor belt is embodied as sufficiently pressure-stable to remain between the pressing table and the substrate during the pressure-sintering process. To enable advancing the substrates, the conveyor belt extends directly above the pressing table. The protective film is disposed between the substrate, with the components disposed thereon, and the pressing die.

The associated clocked method for pressure-sintered bonding of a plurality of chiplike components having a conductor track with the substrate by means of the aforementioned apparatus, comprises the following steps per timing cycle:

Advancing a substrate, with components disposed thereon, to the pressing table by means of the conveyor belt.

Covering the top side of the substrate, i.e., the side with the components disposed thereon, with a protective film.

Pressing the pressing die against the composite comprising the film, components, and substrate, whereby, the special pressure sintered bond is made by the counterpressure that is produced by the pressing table.

Releasing the pressure and advancing the substrate on the conveyor belt.

These method steps are repeated cyclically, and, as a result, an ongoing production of substrates with components disposed thereon by means of pressure-sintering methods is achieved.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The attainment of the object of the invention will be described in further detail in terms of the exemplary embodiments of FIGS. 1 through 3.

FIG. 1 is a schematic representation of a preferred embodiment of the inventive apparatus.

FIG. 2 shows a first stage in the method of the invention.

FIG. 3 shows a further stage in the method of the invention.

### DETAILED DESCRIPTION OF THE PRESENTLY PREFERRED EMBODIMENTS

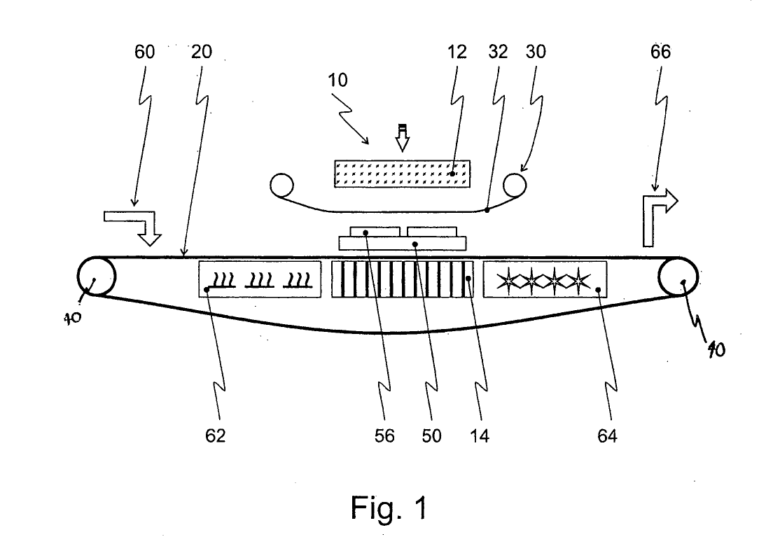

FIG. 1 shows an embodiment of an apparatus according to the invention. A pressing device 10 comprises a pressing die 12 and a heatable pressing table 14. Pressing table 14 is fixedly mounted and forms a body for exerting counterpressure against movable pressing die 12. A conveyor belt 20 extends directly above the pressing table 14 and is shown here as an endless belt with two deflection rollers 40.

Conveyor belt 20 carrys a substrate 50 having at least one chiplike component 56 thereon.

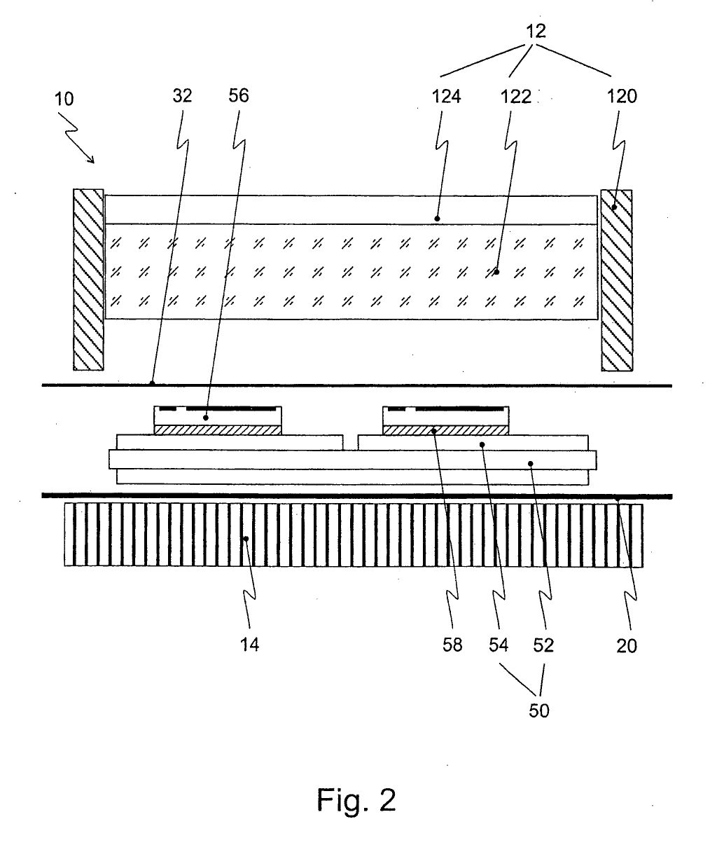

A device 30 is positioned above conveyor belt 20, and is used to cover both substrate 50 and chiplike components 56 disposed on it with a protective film 32. Film 32 protects pressing die 12 against contamination with sintered metal (see 58 in FIG. 2) during the later steps of the method. In a clocked method, this contamination would be deposited on the next substrate 50 on conveyor belt 20 and thus lead to contamination of the system and/or of the processed substrates and hence in the final analysis to a disruption of the continuous production process. An especially well-suited method for applying protective film 32 is shown here. Protective film 32 is disposed in a device in which it is unrolled from one side of pressing device 10 and rolled up again on the other side as substrates 50 pass below. Each substrate 50 is thus covered with a new portion of protective film 32.

Advantageous stations in the apparatus are also shown. For loading conveyor belt 20, a loading station 60 is used. Adjoining it is a preheating station 62 for warming substrate 50, disposed upstream of the actual pressing device 10. A cooling station 64 and an adjacent unloading station 66 are disposed downstream of the pressing device 10. All these stations are connected by conveyor belt 20.

FIG. 2 shows one stage of the method of the invention. What is shown is the stage when a substrate 50 has already been advanced onto the pressing table 14. Substrate 50 here is a ceramic substrate 52 with metal linings 54 on both main faces. Such substrates 50 are often used for power semiconductor modules. To that end, the metal lining 54 of the main face associated with the components 56 is as a rule intrinsically structured and thus forms conductor tracks in a desired pattern.

Chiplike components 56 are disposed on these conductor tracks. In the preferred embodiment, components 56 are power semiconductor components, such as power diodes, power thyristors, and/or power transistors.

A sintered metal 58 is disposed between metal lining 54 and components 56. For pressure-sintered bonding, it is especially preferred if both metal lining 54 and the side of component 56 to be bonded have a precious-metal surface.

A portion of conveyor belt 20 is also shown. This portion extends directly above pressing table 14 and is preferably formed as a high-grade steel band having a thickness of between about 0.2 mm and about 1 mm.

Protective film 32 is shown disposed above substrate 50; it is preferably designed as a Teflon film with a thickness of between about 50 μm and about 300 μm. It is especially preferred if protective film 32 is first disposed in the interior of the pressing device 10 on substrate 50 with components 56 positioned thereon. Alternatively, protective film 32 can also be disposed even upstream of the pressing device 10 by means of an associated device 30.

Pressing die 12 of pressing device 10 has a movable frame 120 and a pressure cushion 124, movable independently of frame 120 and disposed on a die 122, the pressure cushion preferably being made of a silicone compound.

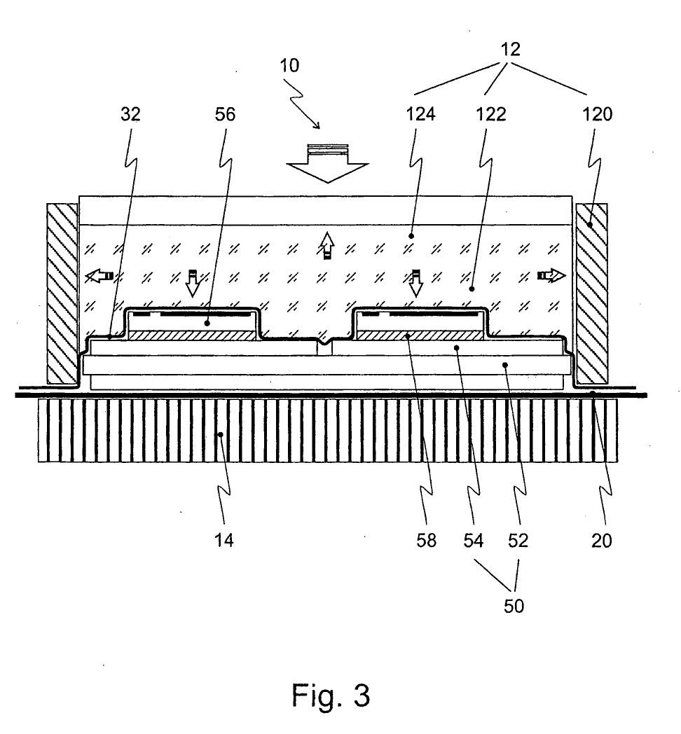

FIG. 3 shows a further step in the method of the invention. Here movable frame 120 of pressing die 12 has been lowered onto conveyor belt 20. Conveyor belt 20 is pressed against pressing table 14, and in a further step, pressure cushion 122 is lowered onto protective film 32; protective film 32 therefore adapts to the contours of substrate 50 with components 56 disposed thereon. By further increasing the pressure on pressure cushion 122 from about 30 to about 60 N/mm², the pressure-sintered bond between the components 56 and the conductor tracks 54 is formed.

The pressure introduction takes place quasi-hydrostatically, since the pressure cushion 122 comprises a silicone compound, and this compound exhibits a flow behavior under pressure that is comparable to that of a liquid. This quasi-hydrostatic distribution onto all surfaces on the one hand brings about a pressure-sintered bonding of all components 56, without on the other hand damaging the substrate 50.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We I claim:

1. An apparatus for a clocked method for pressure-sintered bonding of components to a substrate having conductor tracks, said apparatus comprising;
a pressing device having a pressing die and a heatable pressing table;
a pressure-stable conveyor belt disposed above said pressing table; and
means for covering said substrate having said components thereon with a protective film, said protective film being disposed between said substrate, with said components disposed thereon, and said pressing die;
wherein said pressing device is operable in a clocked mode.

2. The apparatus of claim 1, wherein said pressing die includes a movable frame and a pressure cushion, said pressure cushion being movable independently of said frame and comprising a silicone compound that has a quasi-hydrostatic distribution over all surfaces.

3. The apparatus of claim 1, wherein said components include power semiconductor components, said substrate is a ceramic substrate with metal linings on both main faces thereof; said conveyor belt is a high-grade steel band with a thickness of between about 0.2 mm and about 1 mm; and said protective film is a Teflon film with a thickness of between about 50 μm and about 300 μm.

4. The apparatus of claim 3, wherein said power semiconductor components are selected from the group consisting of power diodes, power thyristors and power transistors.

5. The apparatus of claim 1, further comprising;
a loading station disposed upstream of said pressing device along said conveyor belt;
a preheating station for warming the substrate also disposed upstream of said pressing device along said conveyor belt;
a cooling station disposed downstream of said pressing device along said conveyor belt; and
an unloading station also disposed downstream of said pressing device along said conveyor belt.

6. A clocked method for pressure-sintered bonding of a plurality of components to a substrate having at least one conductor track on a top side thereof, said method comprising the steps of:
placing a substrate having at least one component thereon on a conveyor belt;
advancing said substrate to a pressing table by means of a conveyor belt;
covering said top side of said substrate with a protective film;
pressing a pressing die against the composite comprising said film, components and substrate, and by means of counterpressure exerted by said pressing table forming thereby a pressure-sintered bond therebetween;
releasing said pressure;
advancing said conveyor belt; and
repeating these steps cyclically.

7. The method of claim 6, wherein said substrate, with said components thereon, is covered with said protective film by means of an associated device upstream of the pressing device.

8. The method of claim 6,
wherein said substrate, with said components thereon, is covered with said protective film by means of an associated device in the interior of the pressing device.

9. The method of claim 6 further comprising the steps of:
lowering a movable frame of a pressing die down to said conveyor belt; and
lowering a pressure cushion onto said protective film, and applying, through said pressure cushion, a quasi-hydrostatic pressure via said protective film onto said components and said substrate.
